(19) United States
(12) Patent Application Publication
(10) Pub. No.: US 2011/0095983 A1
(43) Pub. Date: Apr. 28, 2011

(54) OPTICAL INPUT DEVICE AND IMAGE SYSTEM

(75) Inventors: Chih Hung LU, Taiwan (CN); Cho Yi LIN, Taiwan (CN); Yao Ching HSU, Taiwan (CN)

(73) Assignee: PIXART IMAGING INC., Hsin-Chu County (CN)

(21) Appl. No.: 12/944,376

(22) Filed: Nov. 11, 2010

Related U.S. Application Data
(63) Continuation-in-part of application No. 12/605,200, filed on Oct. 23, 2009.

(51) Int. Cl. G06F 3/033

(52) U.S. Cl. 345/166

(57) ABSTRACT

An optical input device includes at least two bodies for being moved on a surface, and a processing unit for obtaining a relative motion between the bodies and for updating the picture shown by the image display according to the relative motion. The present invention further provides an image system.

### CROSS REFERENCE TO RELATED APPLICATION

This application is a continuation-in-part application of U.S. Ser. No. 12/605,200, filed on Oct. 23, 2009, the full disclosure of which is incorporated herein by reference.

### BACKGROUND

1. Field of the Invention

This invention generally relates to an optical input device and an image system and, more particularly, to an optical input device with multi-touch functions and an image system including the same.

2. Description of the Related Art

A conventional optical displacement detector, e.g. an optical mouse, generally includes a light source, an image sensor and a processing unit. The image sensor is for successively capturing a plurality of images. The light source is for providing light to the image sensor during image capturing. The processing unit compares the captured images and obtains a displacement of the optical displacement detector.

Please refer to FIG. 1, it shows a conventional optical mouse 9 and its corresponding image displaying system, which includes an image display 8 and a host 7. A cursor 81 is generally shown on the screen of the image display 8. The host 7 is coupled to the image display 8 for communicating information to and from the image display 8. The displacement obtained by the optical mouse 9 will be transmitted to the host 7 to be processed and the host 7 will send the processed results to the image display 8. In this manner, a user can interact with a program being executed by the host 7 through operating the optical mouse 9 and the cursor 81, and the image display 8 shows the interaction results. However, a conventional optical mouse 9 can only be used to control a single cursor and thus has limited functions. For example, a user can perform icon-selection or scrolling operation through the function keys formed on the optical mouse 9 but can not perform zoom-in, zoom-out and rotating operations by using the optical mouse 9 alone.

Accordingly, it is necessary to further provide an optical input device that can achieve multi-touch functions without incorporating with other computer peripherals so as to increase the practicality of the optical input device.

### SUMMARY

The present invention provides an optical input device and an operating method thereof that have the functions of traditional optical input device and multi-touch functions at the same time thereby effectively improving the practicality of the optical input device.

The present invention provides an image system that can achieve multi-touch functions without utilizing a touch screen thereby significantly reducing the system cost.

The present invention provides an optical input device for controlling an image display and at least one cursor shown on the image display. The optical input device includes a main body, a first body, a second body and a processing unit. The main body, the first body and the second body are for being moved on a surface. The processing unit obtains displacement information of the main body on the surface, a first relative motion between the first body and the main body, and a second relative motion between the second body and the main body; and controls the cursor according to the displacement information, and updating pictures shown by the image display according to the first relative motion and the second relative motion.

The present invention further provides an optical input device for controlling an image display. The optical input device includes at least two bodies for being moved on a surface and a processing unit. The processing unit obtains a third relative motion between the bodies and updating pictures shown by the image display according to the third relative motion.

The present invention further provides an image system including an image display, a host and an optical input device. The image display shows a picture containing at least one cursor. The host is for controlling the image display. The optical input device includes a main body, a first body, a second body and a processing unit. The main body, the first body and the second body are for being moved on a surface. The processing unit calculates displacement information of the main body on the surface to accordingly control the cursor, and calculates a relative motion between the main body, the first body and the second body to accordingly update the picture shown by the image display.

The optical input device and the image system can achieve multi-touch functions, e.g. object-rotating operation, zoom-in operation, zoom-out operation, window-expanding operation and window-shrinking operation, by means of simultaneously controlling at least two control components. Furthermore, the optical input device and the image system of the present invention can be operated in conjunction with a traditional optical mouse so as to significantly increase the practicality of the optical input device as well as reduce the system cost.

### BRIEF DESCRIPTION OF THE DRAWINGS

Other objects, advantages, and novel features of the present invention will become more apparent from the following detailed description when taken in conjunction with the accompanying drawings.

FIG. 1 shows a schematic diagram of a conventional optical mouse and its corresponding image system.

FIG. 2 shows a schematic diagram of an optical input device and its corresponding image system in accordance with an embodiment of the present invention.

FIG. 3 shows a schematic diagram of an optical input device in accordance with another embodiment of the present invention.

FIG. 4a shows a schematic diagram of the optical input device according to the embodiment of the present invention, wherein the optical input device is in the normal mode.

FIG. 4b shows another schematic diagram of the optical input device according to the embodiment of the present invention, wherein the optical input device is in the multi-touch mode.

FIG. 5a shows a schematic diagram of performing left-click and right-click operations with the optical input device according to the embodiment of the present invention.

FIG. 5b shows a schematic diagram of performing scrolling operation with the optical input device according to the embodiment of the present invention.

FIG. 5c shows a schematic diagram of performing zoom-in and zoom-out operations with the optical input device according to the embodiment of the present invention.

FIG. 5d shows a schematic diagram of performing object-rotating operation with the optical input device according to the embodiment of the present invention.

FIG. 5e shows a schematic diagram of performing window-expanding and window-shrinking operations with the optical input device according to the embodiment of the present invention.

FIG. 5f shows a schematic diagram of performing object-drag operation with the optical input device according to the embodiment of the present invention.

FIG. 6a shows a schematic diagram of an optical input device in accordance with an alternative embodiment of the present invention, wherein the optical input device further includes a mode switch.

FIG. 6b shows a schematic diagram of the optical input device shown in FIG. 6a with the mode switch being pressed.

FIG. 7 shows a schematic diagram of the optical input device in accordance with the second embodiment of the present invention.

FIG. 8 shows a schematic diagram of performing left-click and right-click operations with the optical input device according to the second embodiment of the present invention.

FIG. 9a-9c show schematic perspective views of the optical input device in accordance with the second embodiment of the present invention.

FIG. 10a-10c show another schematic perspective views of the optical input device in accordance with the second embodiment of the present invention.

### DETAILED DESCRIPTION OF THE EMBODIMENT

It should be noticed that, wherever possible, the same reference numbers will be used throughout the drawings to refer to the same or like parts.

Please refer to FIG. 2, it shows a schematic diagram of the image system in accordance with an embodiment of the present invention, which includes an optical input device 1, a host 7 and an image display 8. The optical input device 1 is normally put on a surface “S” for being operated by a user 6, wherein the surface “S” may be a suitable surface, e.g. a table surface, the surface of a mouse pad or a paper surface. The optical input device 1 is for detecting at least one relative displacement with respect to the surface “S” and transmits the displacement and operation information to the host 7. The host 7 controls the motion of a cursor 81 shown on the image display 8 according to the displacement, and/or controls the operation of programs installed in the host 7 according to the operation information and updates images shown on the image display 8. The optical input device 1 may wirelessly communicate with the host 7 or be electrically coupled to the host 7 through, for example, USB interface or PS2 interface. Embodiments of the image display 8 include, but not limited to, a computer screen, a television, a projection screen and the screen of a game machine.

The optical input device 1 includes a first body 11, a second body 12, a connecting component 13 and a processing unit 14. The connecting component 13 is configured to connect the first body 11 and the second body 12. In one embodiment, the connecting component 13 may be fixed on the first body 11 and the second body 12 is movably connected to the connecting component 13. In another embodiment, the connecting component 13 may be a signal line that connects the first body 11 and the second body 12. In an alternative embodiment, the first body 11 and the second body 12 may be physically separated from each other and be coupled with each other through wireless communication, e.g. Bluetooth communication. The processing unit 14 may be disposed inside the first body 11 or the second body 12 for obtaining position information of the first body 11 with respect to the surface “S”, a relative variation between the second body 12 and the first body 11 and/or position information of the second body 12 with respect to the surface “S”.

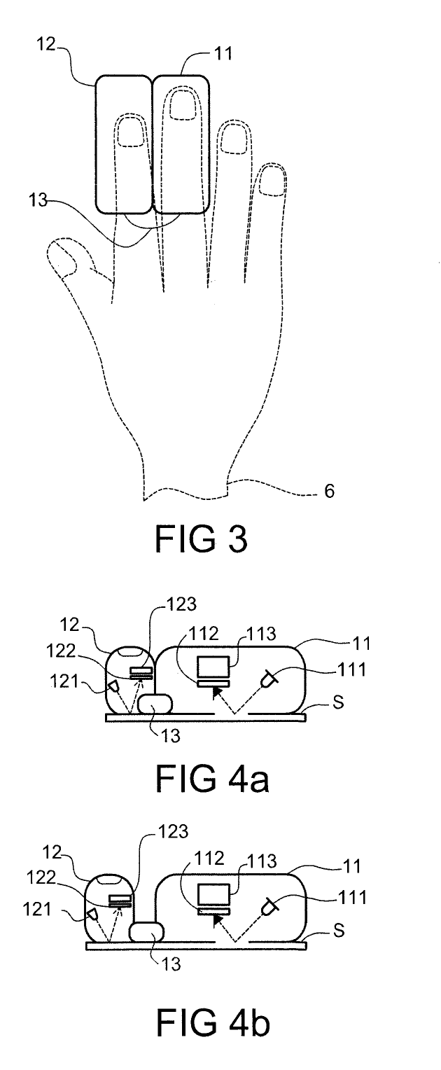

In the embodiment of FIG. 2, the first body 11 is operated by the palm of the user 6 and the second body 12 is operated by the thumb of the user 6. But the present invention are not limited to these, the optical input device 1 of the present invention may be designed as the one shown in FIG. 3, i.e. the first body 11 and the second body 12 are both designed for being operated by fingers of the user 6, but the fingers are not limited to the forefinger and the middle finger shown in FIG. 3. The optical input device 1 of the present invention includes two bodies for being operated by different parts of a user.

Please refer to FIG. 2 again, when the first body 11 and the second body 12 of the optical input device 1 are combined together, the optical input device 1 is for controlling the motion of a single cursor 81 shown on the image display 8, and this case is referred as a normal mode herein. When the first body 11 is separated (or partially separated) from the second body 12, e.g. the second body 12 is changed from state 12 to 12′, the optical input device 1 enters a multi-touch mode and sends the mode-switch information through a transmission interface unit (not shown) to the host 7. Then, the host 7 accordingly controls the image display 8 to show two independent cursors 81 and 81′ on its screen. In one embodiment, a distance between the cursors 81 and 81′ may be determined according to a separated distance between the first body 11 and the second body 12. In another embodiment, when the optical input device 1 enters the multi-touch mode, a predetermined distance may be set between the cursors 81 and 81′.

When the connecting component 13 is fixed between the first body 11 and the second body 12, the connecting component 13 may be served as the center of rotation of the second body 12 such that the second body 12 can make a relative motion with respect to the first body 11, e.g. far apart from or close to the first body 11. When the connecting component 13 is a signal line, the first body 11 and the second body 12 may be physically separated from each other and be electrically coupled with each other only through the connecting component 13. In addition, a detection device 15, for example, but not limited to, a contact switch or a press switch, may be formed on the first body 22, the second body 12 or the connecting component 13 for detecting a combining state or a separation state between the first body 11 and the second body 12. In addition, the connecting component 13 is not limited to the aforementioned embodiments and may be implemented by other kinds of connecting components to allow the first body 11 and the second body 12 to make relative motion.

Please refer to FIGS. 4a and 4b, they show an embodiment of the optical input device 1 of the present invention, wherein FIG. 4a shows the combining state between the first body 11 and the second body 12 (normal mode) and FIG. 4b shows the separation state between the first body 11 and the second body 12 (multi-touch mode). In one embodiment, in the normal mode, the image display 8 only shows one cursor (e.g. cursor 81). The first body 11 is moved on the surface “S”, and the processing unit 14 calculates a first displacement of the first body 11 with respect to the surface “S” and then transmits the first displacement to the host 7 to correspondingly control the motion of the cursor 81. In the multi-touch mode, the image display 8 may simultaneously show two cursors 81 and 81′, and the first body 11 and the second body 12 may be moved on the surface “S” individually. The processing unit 14 calculates a first displacement of the first body 11 with respect to the surface “S”, a second displacement of the second body 12 with respect to the surface “S”, and a relative variation between the first body 11 and the second body 12. Then, the first displacement, the second displacement and the relative variation will be transmitted to the host 7 to correspondingly control the motion of the cursors 81 and 81′.

In another embodiment, the first body 11 includes a first light source 111, a first image sensor 112 and a first processing unit 113. The first image sensor 112 is for capturing a plurality of images. The first light source 111 is for providing light to the first image sensor 112 during image capturing. The first processing unit 113 obtains the first displacement of the first body 11 with respect to the surface “S” according to the captured images, e.g. calculating the first displacement according to the correlation between two images or other know methods. The first light source 111 may be, for example, a light emitting diode or a laser diode. In one embodiment, the light source 111 may be an IR light emitting diode or an IR laser diode. The first image sensor 112 may be, for example, a CCD image sensor or a CMOS image sensor. The first processing unit 113 may be, for example, a digital signal processor (DSP). Furthermore, according to different embodiments, the first body 11 may further include a plurality of lens or lens set for adjusting the light emitted from the first light source 11; an optical filter for blocking the light with a band outside the optical band of the light emitted by the light source 11; and a first transmission interface unit (not shown) for transmitting the first displacement to the host 7.

The second body 12 performs a relative motion with respect to the first body 11 and/or detects a second displacement thereof with respect to the surface “S”. The second displacement may be transmitted to the host 7 through the first transmission interface unit installed inside the first body 11 or a second transmission interface unit installed inside the second body 12. The second body 12 includes a second light source 121, a second image sensor 12 and a second processing unit 123, wherein the functions and types of the second light source 121, the second image sensor 122 and the second processing unit 122 are respectively identical to those of the first light source 111, the first image sensor 112 and the first processing unit 113 and thus details will not be repeated herein. In another embodiment, the optical input device 1 may include only one processing unit 14 to replace the first processing unit 113 and the second processing unit 123.

However, the structure of the second body 12 is not limited to that shown in FIGS. 4a and 4b. In another embodiment, the second body 12 may further include a motion sensor such that the second body 12 can sense the motion thereof through the motion sensor so as to determine the relative motion of the second body 12 with respect to the first body 11 after the optical input device 1 enters the multi-touch mode. In an alternative embodiment, the second image sensor 122 in the second body 12 may be used for detecting the distance or relative position with respect to the first body 11. In this manner, it is able to detect the relative motion between the second body 12 and the first body 11 after the optical input device 1 enters the multi-touch mode. In the present invention, after the optical input device 1 enters the multi-touch mode, multi-touch operations can be performed through detecting the relative position change or the motion between the first body 11 and the second body 12 and determining whether the change or motion matches a predetermined relationship, e.g. left-click, right-click, icon-selection, scrolling, zoom-in, zoom-out, object-rotating, window-expanding, window-shrinking or object-drag operation.

Next, embodiments of executable operations of the optical input device 1 of the present invention and relative operating methods will be illustrated. It could be understood that, although the illustrations below are made in conjunction with FIG. 3, modifications and variations can be made by those skilled in the art without departing from the spirit and scope of the invention. In the illustrations below, it is assumed that the optical input device 1 is initially operated in the normal mode, i.e. the first body 11 and the second body 12 are combined together and the image display 8 shows only one cursor. It is further assumed that the second body 12 is positioned left to the first body 11. But these assumptions are not used to limit the present invention.

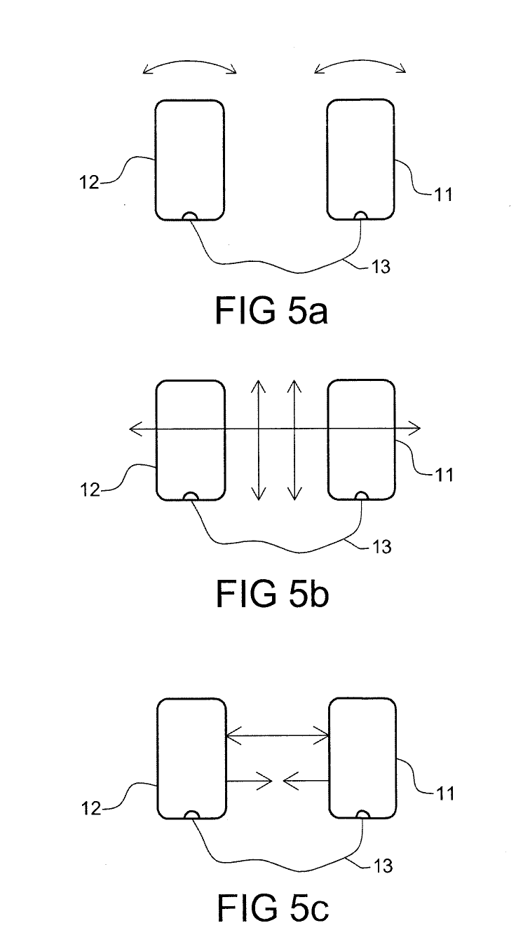

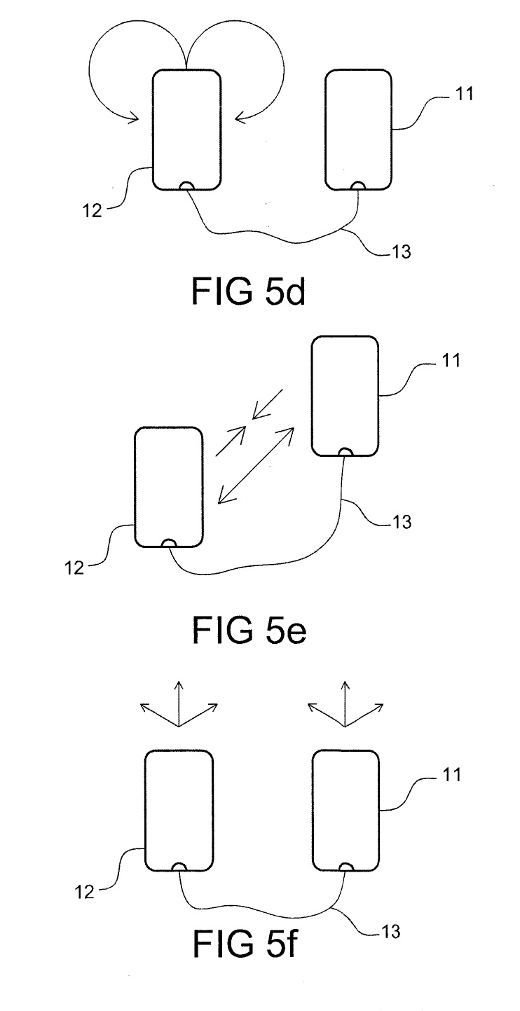

Left-click and Right-click operations (Icon-Selection): Please refer to FIG. 5a, when a user wants to use the optical input device 1 to perform left-click and right-click operations, the user first separates the first body 11 and the second body 12 to enter the multi-touch mode. Next, when two cursors 81 and 81′ are shown on the screen of the image display 8, the first body 11 and the second body 12 can control the motion of a cursor respectively. At this moment, the user moves the second body 12 left and right (the cursor 81′ is also moved left and right), and the host 7 recognizes that the user is performing left-click operation after receiving signals from the optical input device 1. On the other hand, when the user moves the first body 11 left and right (the cursor 81 is also moved left and right), the host 7 recognizes that the user is performing right-click operation. In addition, when the user performs the above left-click operation with a cursor on an icon, the host 7 recognizes that the user is performing icon-selection operation; this moment the host 7 executes a corresponding program or software according to the one selected by the user and updates images displayed by the image display 8. When the user combines the first body 11 and the second body 12 together, the optical input device 1 returns to the normal mode again.

Scrolling operation: Please refer to FIG. 5b, when a user wants to use the optical input device 1 to perform scrolling operation, the user first separates the first body 11 and the second body 12 to enter the multi-touch mode. Next, the user simultaneously moves the first body 11 and the second body 12 upward and downward or toward left and toward right, and the host 7 identifies that the user is performing the scrolling operation and controls the update of the image display 8 to show corresponding images.

Zoom-in and Zoom-out operations: Please refer to FIG. 5c, when a user wants to use the optical input device 1 to perform zoom-in and zoom-out operations, the user first separates the first body 11 and the second body 12 to enter the multi-touch mode. Next, when the user shortens the distance between the first body 11 and the second 12, the distance between the cursors 81 and 81′ is also shortened, and the host 7 recognizes that the user is performing zoom-in operation. On the other hand, when the user increases the distance between the first body 11 and the second 12, the distance between the cursors 81 and 81′ is also increased, and the host 7 recognizes that the user is performing zoom-out operation. In another embodiment, when the distance between the first body 11 and the second body 12 is increased, it may represent that the user is performing zoom-in operation; while when the distance between the first body 11 and the second body 12 is shortened, it may represent that the user is performing zoom-out operation.

Object-rotating operation: Please refer to FIG. 5d, when a user wants to use the optical input device 1 to perform object-rotating operation, the user first moves the cursor 81 to an object to be rotated and then separates the first body 11 and the second body 12 to enter the multi-touch mode. Next, the user rotationally moves the first body 11 and/or the second body 12 clockwise or counterclockwise so as to rotate the selected object.

Window-expanding and Window-shrinking operations: Please refer to FIG. 5e, when a user wants to use the optical input device 1 to perform window-expanding or window-shrinking operations, the user first moves the cursor 81 to a window to be changed and then separates the first body 11 and the second body 12 to enter the multi-touch mode. Next, the user may diagonally increase the distance between the first body 11 and the second body 12 to perform window-expanding operation or diagonally decrease the distance between the first body 11 and the second body 12 to perform window-shrinking operation. In another embodiment, when the optical input device 1 is controlled to enter the multi-touch mode with the cursor 81 upon a window, it also can be set that the window-expanding and window-shrinking operations may be performed only by increasing or decreasing a distance between the first body 11 and the second body 12 without the need to change the distance between the first body 11 and the second body 12 toward a particular direction.

Object-drag operation: Please refer to FIG. 5f, when a user wants to use the optical input device 1 to perform object-rotating operation, the user first moves the cursor 81 to an object to be rotated and then separates the first body 11 and the second body 12 to enter the multi-touch mode. Next, the user moves the first body 11 and the second body 21 together toward a direction that the object to be dragged so as to perform object-drag operation.

The above functions and operating methods are only exemplary embodiments and are not used to limit the present invention. The optical input device 1 of the present invention can achieve different operational functions according to different settings, e.g. object revolving.

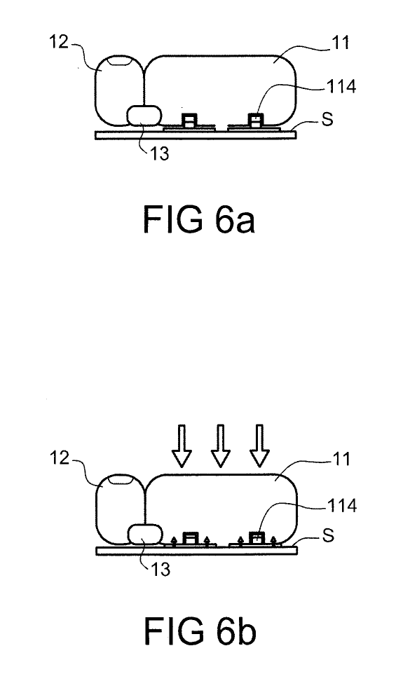

In an alternative embodiment, a mode switch 114 may be further formed at the bottom surface of the first body 11 and/or the second body 12, as shown in FIGS. 6a and 6b. When the mode switch 114 is not triggered (as FIG. 6a), the optical input device 1 operates in the normal mode; but when the mode switch 114 is triggered (as FIG. 6b), even though the first body 11 and the second body 12 of the optical input device 1 are not separated, the optical input device 1 still can control the update of the image display 8 so as to perform, for example, object-drag or scrolling operation. For example, when a user utilizes the optical input device 1 in the normal mode to control the cursor 81 to upon an object and then presses the mode switch 114 and if the user moves the optical input device 1, it is able to perform object-drag operation. When the user presses the mode switch 114 with the cursor 81 being not upon a particular object and if the user moves the optical input device 1, it is able to perform scrolling operation. The mode switch 114 may be a mechanical switch or an electronic switch.

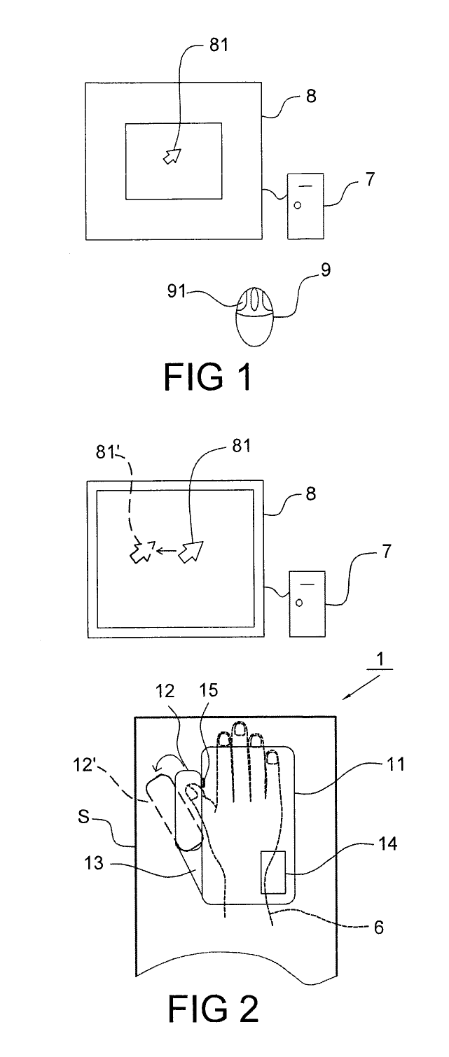

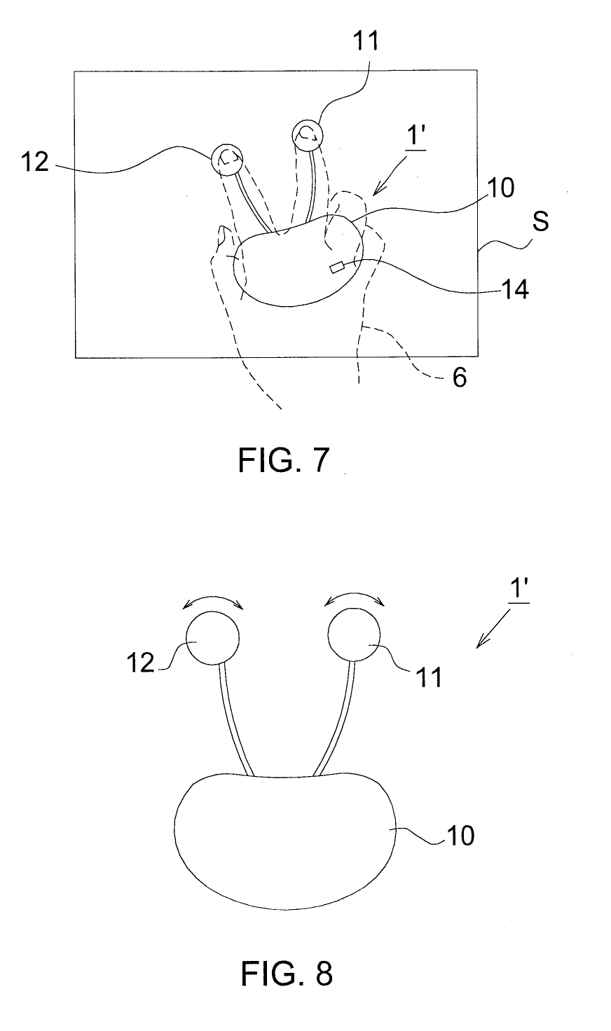

Please refer to FIG. 7, it shows a schematic diagram of the optical input device 1′ in accordance with the second embodiment of the present invention. The optical input device 1′ is also configured to be operated on a surface S. When the optical input device 1′ is adapted to an image system, which includes an image display 8 and a host (as shown in FIG. 1), the optical input device 1′ communicates with the host 7 though a communication interface unit so as to accordingly control the update of pictures shown by the image display 8 and the motion of the cursor 81, wherein the picture may be updated to show picture zooming, object rotating, window zooming, object dragging or picture scrolling. It is appreciated that the host 7 may be integrated inside the image display 8.

The optical input device 1′ includes a main body 10, a first body 11 and a second body 12. The optical input device 1′ further includes a processing unit 14 configured to calculate displacement information of the main body 10 with respect to the surface S so as to accordingly control the motion of the cursor 81, and to calculate a relative motion between the main body 10, the first body 11 and the second body 12 so as to accordingly update the picture shown by the image display 8, wherein the process that the processing unit 14 controls the motion of the cursor 81 according to the displacement information of the main body 10 with respect to the surface S is a well known skill, e.g. controlling the motion of a cursor with an optical mouse, and thus details will not be repeated herein. It is appreciated that the processing unit 14 is not limited to be integrated inside the main body 10 and it may also be integrated inside the first body 11 or the second body 12. The first body 11 and the second body 12 are wirelessly or electrically connected to the main body 10. When the first body 11 and the second body 12 are electrically connected to each other, the electrical connection is not limited to any specific type as long as the first body 11 and the second body 12 are movable with respect to the main body 10.

In one embodiment, the processing unit 14 updates the picture shown by the image display 8 according to a first relative motion between the first body 11 and the main body 10 and according to a second relative motion between the second body 12 and the main body 10, wherein the first relative motion and the second relative motion may be those shown in FIGS. 5a to 5f. Although FIGS. 5a to 5f show relative motions between the first body 11 and the second body 12, a person skilled in the art can understand that those relative motions may also be served as relative motions of the first body 11 and the second body 12 with respect to the main body 10, respectively.

### Left Click and Right Click (Icon Selection)

Please refer to FIGS. 5a and 8, FIG. 5a shows the relative motion between the first body 11 and the second body 12 while FIG. 8 shows the relative motion between the first body 11 and the main body 10 and between the second body 12 and the main body 10. When a user moves the second body 12 leftward and rightward reciprocally (i.e. the second relative motion is set as moving the second body 12 leftward and rightward reciprocally with respect to the main body 10), and the host 7 recognizes that the user is performing left-click gesture after receiving signals from the optical input device 1′. On the other hand, when the user moves the first body 11 leftward and rightward reciprocally (i.e. the first relative motion is set as moving the first body 11 leftward and rightward reciprocally with respect to the main body 10), the host 7 recognizes that the user is performing right-click gesture. In addition, when the user performs the left-click gesture mentioned above with a cursor upon an icon, the host 7 recognizes that the user is performing icon-selection gesture and then executes a corresponding program or software according to the one selected by the user and updates pictures displayed on the image display 8.

Similarly, the processing unit 14 may recognize relative motions of the first body 11 and the second body 12 with respect to the main body 10 according to FIGS. 5b-5f so as to accordingly control the image display 8 to perform picture scrolling, picture zooming, object rotating, window zooming and object dragging functions, wherein a function corresponding to the relative motion of the first body 11 and second body 12 with respect to the main body 10 may be set according to actual operations and is not limited to those shown in FIGS. 5a-5f. The method for detecting the first relative motion and the second relative motion will be illustrated by examples hereinafter, but the present invention is not limited thereto.

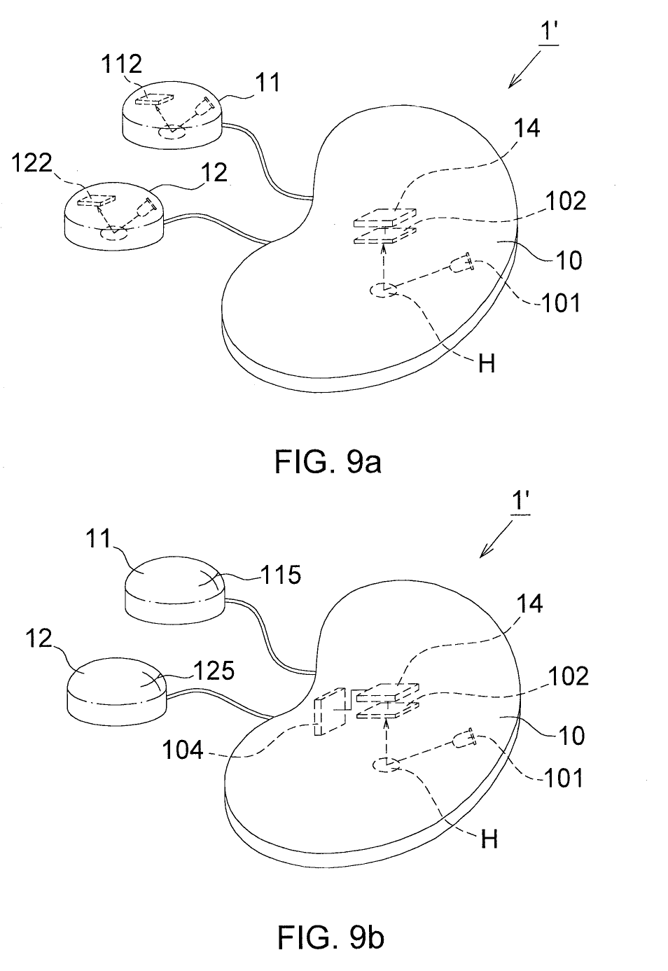

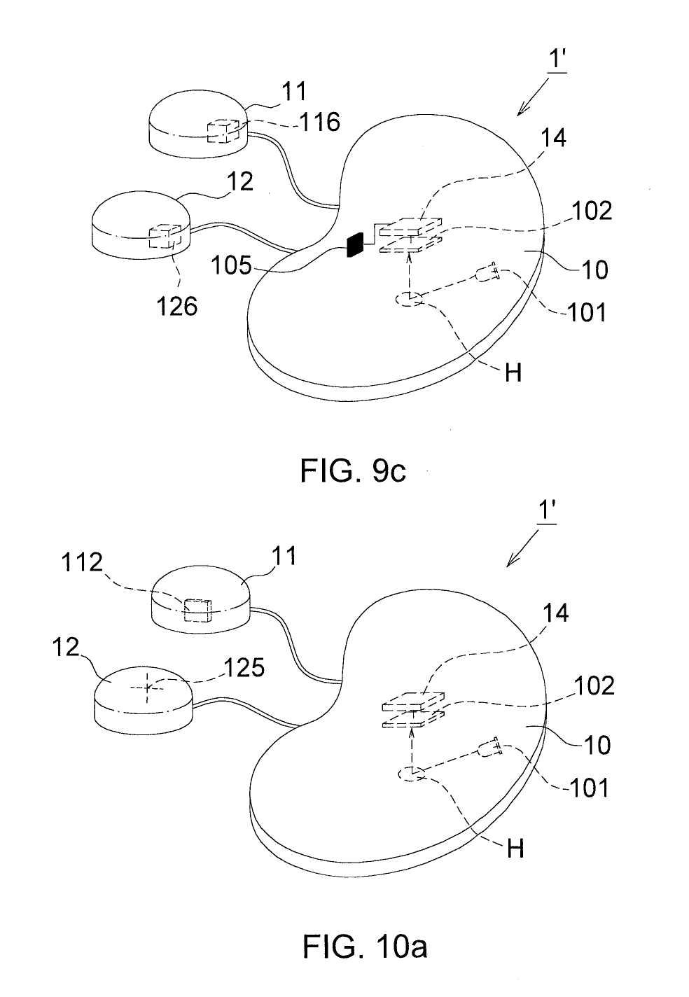

Please refer to FIG. 9a, it shows an exemplary aspect of the optical input device 1′ according to the second embodiment of the present invention. The optical input device 1′ includes a main body 10, a first body 11 and a second body 12. The main body 10 includes a light source 101 and a third image sensor 102, wherein the third image sensor 102 is configured to capture images of the surface S and the light source 101 is configured to provide the needed light while the third image sensor 102 is capturing images. Furthermore, the main body 10 further includes other components not shown in FIG. 9a, e.g. a lens disposed in front of the third image sensor 102 or some components included in a conventional optical mouse. The first body 11 and the second body 12 respectively include an image sensor and a light source, as shown in FIGS. 4a and 4b. The processing unit 14 obtains displacement information of the main body 10 with respect to the surface S according to the images captured by the third image sensor 102, obtains a first displacement of the first body 11 with respect to the surface S according to the images captured by a first image sensor 112 included in the first body 11, obtains a second displacement of the second body 12 with respect to the surface S according to the images captured by a second image sensor 122 included in the second body 12; wherein the displacement may be obtained according to the correlation between captured images. Accordingly, the processing unit 14 may obtain the first relative motion according to the displacement information and the first displacement and may obtain the second relative motion according to the displacement information and the second displacement.

Please refer to FIG. 9b, it shows another exemplary aspect of the optical input device 1′ according to the second embodiment of the present invention. The optical input device 1′ includes a main body 10, a first body 11 and a second body 12. The main body 10 includes a light source 101, a third image sensor 102 and a fourth image sensor 104, wherein the third image sensor 102 is configured to capture images of the surface S and the light source 101 is configured to provide the needed light while the third image sensor 102 is capturing images. The fourth image sensor 104 is configured to capture images of the first body 11 and the second body 12. The processing unit 14 obtains displacement information of the main body 10 with respect to the surface S according to the images captured by the third image sensor 102, and obtains the first relative motion and the second relative motion according to the image variation of the first body 11 and the second body 12 contained in the images captured by the fourth image sensor 104.

In an aspect of the present invention, at least one reference object 115 and 125 is respectively formed, facing the main body 10, on the first body 11 and the second body 12 such that the fourth image sensor 104 may capture their images. The processing unit 14 obtains the first relative motion and the second relative motion according to the image variation of the reference objects 115 and 125 contained in the images captured by the fourth image sensor 104, wherein the reference objects 115 and 125 may be drawn on the shell surface of the first body 11 and the second body 12 or may be proper objects adhesive thereon, e.g. the reference objects may be at least one active or passive light source, or at least one throughhole with particular shape formed on the shell of the first body 11 and the second body 12 such that the light generated by the light source inside the shell may go outside the shell through the throughhole to be captured by the fourth image sensor 104. Since the fourth image sensor 104 only needs to capture images of the first body 11 (or the reference object 115) and the second body 12 (or the reference object 125) for being processed by the processing unit 14 to recognize the relative motion thereof with respect to the main body 10 without identifying detailed information, the resolution of the fourth image sensor 104 may be lower than that of the third image sensor 102. It is appreciated that, in order to allow the fourth image sensor 104 to be able to capture images of the first body 11 (or the reference object 115) and the second body 12 (or the reference object 125), at least a part of the shell of the main body 10, facing a sensor array of the fourth image sensor 104, is transparent, e.g. transparent to the visible light or to the light generated by the light source inside the first body 11 and the second body 12.

Please refer to FIG. 9c, it shows another exemplary aspect of the optical input device 1′ according to the second embodiment of the present invention. The optical input device 1′ includes a main body 10, a first body 11 and a second body 12. The main body 10 includes a light source 101, a third image sensor 102 and a Hall sensor 105, wherein the third image sensor 102 is similar to that shown in FIG. 9a; the Hall sensor 105 is configured to detect a relative distance of a magnetic component 116 disposed inside the first body 11 and a magnetic component 126 disposed inside the second body 12, wherein the fundamentals of the Hall sensor is a well know skill and thus details will not be described herein. The processing unit 14 obtains displacement information of the main body 10 with respect to the surface S according to the images captured by the third image sensor 102, and obtains the first relative motion and the second relative motion according to the relative distance variation detected by the Hall sensor 105.

In another embodiment, the processing unit 14 updates pictures shown by the image display 8 according to a third relative motion between the first body 11 and the second body 12, wherein the third relative motion may be those shown in FIGS. 5a-5f. A function corresponding to the relative motion between the first body 11 and the second body 12 may be set according to actual operations and is not limited to those shown in FIGS. 5a-5f. The method for detecting the third relative motion will be illustrated by examples hereinafter, but the present invention is not limited thereto.

In an aspect of the present invention, the optical input device 1′ includes a main body 10, a first body 11 and a second body 12, and they are similar to those shown in FIG. 9a and thus details will not be repeated herein. The processing unit 14 obtains the displacement information according to the images captured by the third image sensor 102; obtains a first displacement according to the images captured by the first image sensor 112 of the first body 10; obtains a second displacement according to the images captured by the second image sensor 122 of the second body 12; and obtains the third relative motion according to the first displacement and the second displacement. That is, in FIG. 9a, the processing unit 14 updates the picture shown by an image display according to the relative motion of the first body 11 and the second body 12 with respect to the main body 10, while in this aspect the processing unit 14 updates the picture shown by an image display according to the relative motion between the first body 11 and the second body 12.

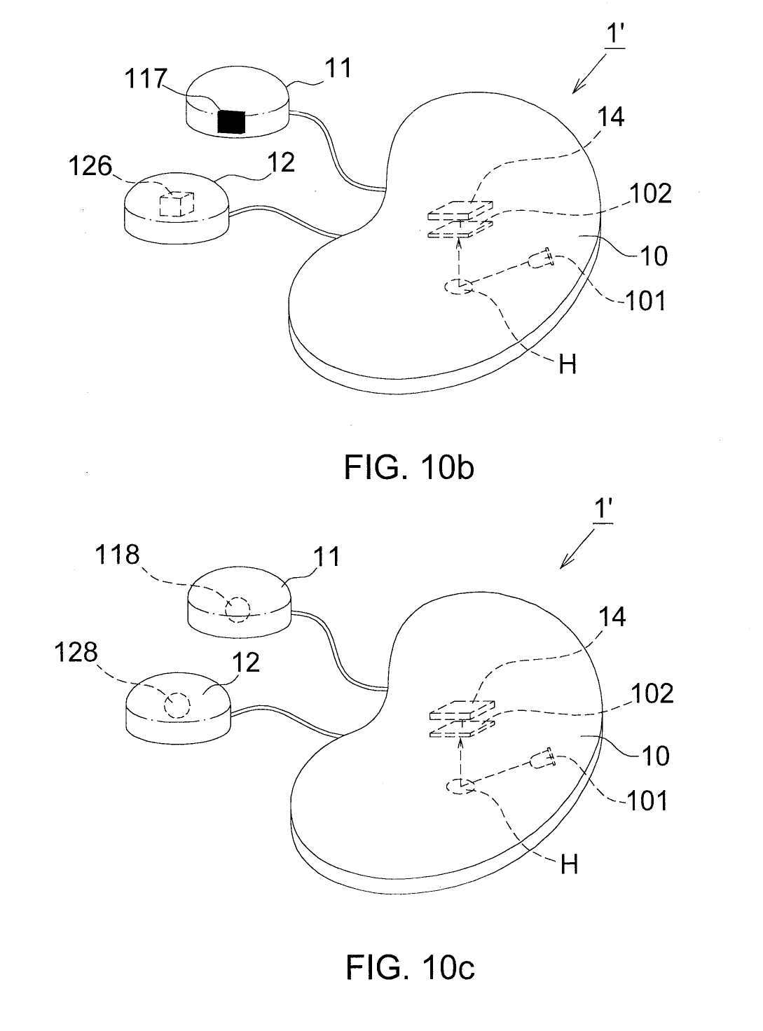

Please refer to FIG. 10a, it shows another exemplary aspect of the optical input device 1′ according to the second embodiment of the present invention. The optical input device 1′ includes a main body 10, a first body 11 and a second body 12. The main body 10 is similar to that shown in FIG. 9a and thus details will not be repeated herein. The first body 11 includes a first image sensor 112 configured to capture images of the second body 12. The processing unit 14 obtains displacement information according to the images captured by the third image sensor 102, and obtains the third relative motion according to the image variation of the second body 12 contained in the images captured by the first image sensor 112. In an aspect, at least one reference 125 may be provided, facing the first body 11, on the second body 12 such that the first image sensor 112 of the first body 11 may capture the image thereof. The processing unit 14 obtains the third relative motion according to the image variation of the reference object 125 contained in the images captured by the first image sensor 112, e.g. identifying a distance variation or a relative position variation respectively according to the size variation and the position variation of the image of the reference object 125. In another aspect, an image sensor is provided inside the second body 12 and a reference object is provided on the first body 11.

Please refer to FIG. 10b, it shows another exemplary aspect of the optical input device 1′ according to the second embodiment of the present invention. The optical input device 1′ includes a main body 10, a first body 11 and a second body 12. The main body 10 is similar to that shown in FIG. 9a and thus details will not be repeated herein. The first body 11 includes a Hall sensor 117 configured to detect a relative distance of a magnetic component 126 disposed inside the second body 12. The processing unit 14 obtains displacement information of the main body 10 with respect to the surface S according to the images captured by the third image sensor 102, and obtains the third relative motion according to a relative distance variation detected by the Hall sensor 105. In another aspect, a Hall sensor is provided inside the second body 12 and a magnetic component is provided inside the first body 11.

Please refer to FIG. 10c, it shows another exemplary aspect of the optical input device 1′ according to the second embodiment of the present invention. The optical input device 1′ includes a main body 10, a first body 11 and a second body 12. The main body 10 is similar to that shown in FIG. 9a and thus details will not be repeated herein. The first body 11 and the second body 12 respectively include a motion sensor 118 and 128, e.g. a G-sensor, to respectively detect the motion of the first body 11 and the second body 12. The processing unit 14 obtains displacement information according to the images captured by third image sensor 102 of the main body 10, and obtains the third relative motion according to the motions of the first body 11 and the second body 12 detected by the motion sensors 118 and 128, respectively.

Furthermore, as shown in FIG. 2, the first body 11 or the second body 12 may further includes a detection device 15 for detecting the combining state of the first body 11 and the second body 12. When the first body 11 is separated from the second body 12, the image display 8 may simultaneously show two cursors 81, 81′ on the screen to facilitate the operation of the optical input device.

As mentioned above, as the conventional optical mouse can not execute multi-touch functions and thus has its limitation. Therefore, the present invention further provides an optical input device (as shown in FIGS. 9a-9c and 10a-10c). It is able to perform multi-touch functions by using the optical input device of the present invention alone according to the relative position and/or relative motion between at least two bodies. Furthermore, the optical input device of the present invention may be operated in conjunction with a traditional optical mouse thereby having higher practicality.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. An optical input device, for controlling an image display and at least one cursor shown on the image display, the optical input device comprising:
a main body, a first body and a second body for being moved on a surface; and
a processing unit, obtaining displacement information of the main body on the surface, a first relative motion between the first body and the main body, and a second relative motion between the second body and the main body; and controlling the cursor according to the displacement information, and updating pictures shown by the image display according to the first relative motion and the second relative motion.

2. The optical input device as claimed in claim 1, wherein the main body, the first body and the second body respectively include an image sensor configured to capture images of the surface; the processing unit obtains the displacement information according to the images captured by the image sensor of the main body, obtains a first displacement according to the images captured by the image sensor of the first body, obtains a second displacement according to the images captured by the image sensor of the second body, obtains the first relative motion according to the displacement information and the first displacement, and obtains the second relative motion according to the displacement information and the second displacement.

3. The optical input device as claimed in claim 1, wherein the main body comprises a third image sensor configured to capture images of the surface and a fourth image sensor configured to captured images of the first body and the second body; the processing unit obtains the displacement information according to the images captured by the third image sensor, and obtains the first relative motion and the second relative motion according to the images captured by the fourth image sensor.

4. The optical input device as claimed in claim 3, wherein at least one reference object is respectively formed on the first body and the second body facing the main body.

5. The optical input device as claimed in claim 1, wherein the main body comprises a third image sensor configured to capture images of the surface and at least one Hall sensor configured to respectively detect a relative distance from the first body and the second body to the main body; the processing unit obtains the displacement information according to the images captured by the third image sensor, and obtains the first relative motion and the second relative motion according to the relative distance.

6. The optical input device as claimed in claim 1, wherein the processing unit is integrated inside the main body, the first body or the second body.

7. The optical input device as claimed in claim 1, wherein the first body and the second body are wirelessly or electrically connected to the main body.

8. An optical input device, for controlling an image display, the optical input device comprising:
at least two bodies, for being moved on a surface; and
a processing unit, obtaining a third relative motion between the bodies and updating pictures shown by the image display according to the third relative motion.

9. The optical input device as claimed in claim 8, wherein the optical input device comprises a main body, a first body and a second body; the processing unit obtains the third relative motion between the first body and the second body, obtains a displacement information of the main body on the surface, and controls a cursor shown on the image display according to the displacement information.

10. The optical input device as claimed in claim 9, wherein the main body is an optical mouse.

11. The optical input device as claimed in claim 8, wherein the first body and the second body respectively comprise an image sensor configured to capture images of the surface; the processing unit obtains a first displacement according to the images captured by the image sensor of the first body, obtains a second displacement according the images captured by the image sensor of the second body, and obtains the third relative motion according to the first displacement and the second displacement.

12. The optical input device as claimed in claim 8, wherein the first body comprises a first image sensor configured to capture images of the second body, and obtains the third relative motion according to the images captured by the first image sensor.

13. The optical input device as claimed in claim 12, wherein at least one reference object is formed on the second body facing the first body.

14. The optical input device as claimed in claim 8, wherein the first body comprises a Hall sensor configured to detect a relative distance between the first and second bodies; and the processing unit obtains the third relative motion according to the relative distance.

15. The optical input device as claimed in claim 8, wherein the first body and the second body respectively comprise a motion sensor; and the processing unit detects the third relative motion by using the motion sensors.

16. An image system, comprising:
an image display, showing a picture containing at least one cursor;
a host, for controlling the image display; and
an optical input device, comprising:
a main body, a first body and a second body, for being moved on a surface; and
a processing unit, calculating displacement information of the main body on the surface to accordingly control the cursor, and calculating a relative motion between the main body, the first body and the second body to accordingly update the picture shown by the image display.

17. The image system as claimed in claim 16, wherein the processing unit updates the picture shown by the image display according to a first relative motion between the first body and the main body and according to a second relative motion between the second body and the main body.

18. The image system as claimed in claim 16, wherein the processing unit updates the picture shown by the image display according to a third relative motion between the first body and the second body.

19. The image system as claimed in claim 16, wherein the optical input device is wirelessly or electrically coupled to the host.

20. The image system as claimed in claim 16, wherein the host is integrated inside the image display.
